(19) United States
(12) Patent Application Publication
(10) Pub. No.: US 2016/0059474 A1
(43) Pub. Date: Mar. 3, 2016

(54) METHOD FOR PROVIDING FEATURES TO A PIPE SURFACE

(71) Applicant: SHAWCOR LTD., Toronto (CA)

(72) Inventors: Per Ove SINGSTAD, Toronto (CA); Kjell Arnfinn KVARSNES, Toronto (CA); Eirik SIMONSEN, Sandefjord (NO); Adam JACKSON, Trondheim (NO)

(21) Appl. No.: 14/780,770

(22) PCT Filed: Mar. 28, 2014
(86) PCT No.: PCT/CA2014/050315

§ 371 Date: Sep. 28, 2015

Related U.S. Application Data
(60) Provisional application No. 61/806,100, filed on Mar. 28, 2013.

(51) Int. Cl. B29C 59/04; F16L 9/08; F16L 59/14; B29C 35/08

(52) U.S. Cl. CPC B29C 59/043; B29C 35/0805; F16L 9/08; F16L 59/143; B29C 2035/0822; B29K 2101/12

(57) ABSTRACT

A process for preparing a coated or thermally insulated plastic coated pipe containing the step of embossing a surface of a thermoplastic wrap on a pipe, wherein the thermoplastic wrap is applied on an outer surface of the pipe. The process can provide a coated or thermally insulated plastic wrapped pipe having features on the surface that are produced in a controlled and repeated manner. Such features can provide benefits, such as, a surface for affixing concrete on the coated or thermally insulated plastic wrapped pipe.

### CROSS-REFERENCE TO RELATED APPLICATION

This is the U.S. National Phase Application under 35 U.S.C. §371 of International Patent Application No. PCT/CA2014/050315 filed Mar. 28, 2015, which claims the benefit of US Provisional patent application Ser. No. 61/806,100, filed Mar. 28, 2013, both of which are incorporated by reference herein.

### FIELD

The specification relates to a method for providing features on a pipe surface and a pipe made according to the process as disclosed herein.

### BACKGROUND

Pipes having a coating layer are typically used in the oil and gas industry for transporting oil or gas. The pipes used generally are wrapped with a plastic material. In some instances, pipes are coated with a plastic material to provide a corrosion protection coating of the pipes, such as, by application of a three-layer system containing a fusion bonded epoxy, a resin adhesive and a solid resin such as polypropylene, polyethylene or polystyrene. While in other embodiments, a thermoplastic based thermal insulation system, such as polypropylene or polystyrene coating, can be applied to pipes. The thermally insulated plastic material is applied to the pipes as a stand-alone system, or alternatively, a concrete layer is applied to the thermally insulated plastic wrap performed by coating via impingement or wrap processing, to form the finished coated pipe.

One of the processes for preparing the pipes involves application of a layer of sintered material through spray or flocking onto the pipe surface while molten or following re-heating. For instance, flocking of a suitable thermoplastic material based granulate can be carried out on a molten pipe surface to coat a pipe. The flocking step can carried out in line or in a subsequent process step with post application coalescence and fusion of the granulate onto the pipe surface, either through the use of the latent heat in the material(s) or through the use of a subsequent heating step.

One of the challenges of the flocking process is that only a small surface area is available for friction or mechanical interaction of the thermoplastic material to the pipe. In addition, it can be difficult to ensure that the size, frequency and adhesion properties of the granulate coating on the treated pipe are consistent. Moreover, shedding of granulate can raise health, safety and environmental (HSE) issues, such as breathing of the material, slipping on material that has shed, or the shed material in the air getting into eyes of operators. Further, due to the potentially unstable nature of the added coating there is a risk of the material shearing from the pipe causing problems in gripping equipment. Moreover, shedding of granulate can reduce effective friction during pipe lay/lifting causing operational problems.

Another process for preparing the pipes involves abrasion of the surface of the coated pipe using suitable abrasion equipment such as belt sanders, rib discs, flap wheels, brushes or others. This process provides a limited ability to induce amplitude in the induced surface texture. In addition, there is potential for creation of loosely attached material with no mechanical/friction contribution. Moreover, the frequency of surface aspect is excessive for provision of mechanical locking. Further, the coating can get removed in the process.

A still another process for preparing pipes involves blasting of the surface of the coated pipe using a suitable refractory blast medium. One of the challenges of this process is that it can be difficult to modify the surface due to dampening properties of the coating material(s). In addition, there is little control of the surface profile generated. Moreover, there is limited ability to induce amplitude in the induced surface texture. Further, the coating can get removed in the process.

There is a need in the art for a process for preparing a coated pipe that can address or mitigate some of the problems in the current processes and the pipes prepared according to the current processes.

### BRIEF DESCRIPTION OF THE DRAWINGS

Reference will now be made, by way of example, to the accompanying drawings which show example embodiments of the present application, and in which:

FIG. 1 shows an embodiment of a device used for embossing a coating or thermally insulated plastic wrap on a pipe;

FIG. 2 shows an embodiment of a device in a second position used for embossing a coating or thermally insulated plastic wrap on a pipe;

FIG. 3 shows a close-up of an embossing wheel, showing the wheel face having the template used for forming impressions;

FIG. 4 shows a picture of an embodiment of a surface of the embossed coated or thermally insulated plastic wrapped pipe;

Similar reference numerals may have been used in different figures to denote similar components.

### DESCRIPTION

In one aspect, the specification relates to a process containing the step of embossing a thermally insulated plastic wrap or coating on a pipe, wherein the thermally insulated plastic wrap or coating is present on an outer surface of the pipe. The method for embossing is not particularly limited. In one embodiment, for example, the step of embossing can involve using a pipe having a coating or thermally insulated plastic wrap on a pipe and subjecting the coating or thermally insulated plastic wrap to irradiation to re-melt or soften the surface of the coating or thermally insulated plastic wrap. Once the surface has been softened, an embossing wheel, shaped mandrel or other similar device can be used to form an impression, such as a textured profile, on the surface of the coating or thermally insulated plastic wrap. Such an impression remains on the surface of the coating or the thermally insulating plastic wrap after some time upon removal of the irradiation source. Consequently, upon cooling or returning to ambient conditions, the permanent impression is formed on the coating on the pipe or the thermally insulating plastic wrap on the pipe.

The method used for irradiation is not particularly limited and should be known to a skilled worker or can be determined In one embodiment, for example, the irradiation is performed using a heat source. The heat source used is not particularly limited, and typically can raise temperature sufficiently to soften the surface of the coating or the thermally insulated plastic wrap. In one embodiment, for example, the heat source is hot air or infrared (IR) radiation. The irradiation of the coated pipe or thermally insulating plastic wrap on the pipe leads to softening of the outer surface of the wrap. The softening of the surface can occur due to, for instance, partial melting of the surface of the coating or the thermally insulated plastic wrap.

The process, as disclosed herein, can provide a high level of surface modification in a predictable and repeatable manner. In addition, as the modified surface on the coating or the thermally insulated plastic wrap is moulded or formed from the existing surface, rather than a post applied system, the mechanical integrity of the overall coated or thermally insulted plastic wrapped pipe can be very high. And moreover, can be designed for specific purposes. Further, embossing on the surface of the coating or the thermally insulating plastic wrap on the pipe can help to provide a roughened surface that can provide traction to personnel that may walk on the pipe. Moreover, embossing on the surface of the coating or the thermally insulating plastic wrap on the pipe can help to provide a roughened surface that can help with affixing any further coating, such as, concrete that is coated on the embossed surface.

In the process, embossing on the surface of the coating or thermally insulated plastic coated wrap on the pipe can form an impression that has a controlled level of depth or amplitude. The amplitude of the impression is not particularly limited, and in one embodiment, for example, can be from 1 to 10 mm, and values in between. In a further embodiment, for example and without limitation, the embossing forms an impression on the coating or thermally insulated plastic wrap on the pipe having an amplitude of from 1 to 5 mm, and values in between.

In addition to the above, in accordance with the process as disclosed herein, embossing on the surface of the coating or thermally insulated plastic coated wrap on the pipe can form an impression that can be repeated on the same or different pipe in a predictable and controlled manner. The frequency of the impression on the coating or the thermally insulating plastic coated wrap is not particularly limited and can depend upon the particular design or application requirements. In one embodiment, for example and without limitation, the frequency of the impression formed on the coating or the thermally insulating plastic wrap on the pipe, along the length of the pipe can range from 1 to 100 mm, and values in between.

An advantage of the process of embossing on the surface of a coating or thermally insulated plastic wrap on a pipe is that it can be performed in line with the coating or placing the thermally insulated plastic wrap on the pipe. Alternatively, the step of embossing can be carried out as a separate activity after production of the coated pipe or wrapping of the pipe with the thermally insulated plastic wrap. Therefore, in one embodiment, for example and without limitation, the step of embossing is carried out concurrently and subsequently to wrapping the pipe with the thermally insulated plastic wrap or coating the pipe with the thermally insulated coating. Alternatively, in another embodiment, for example and without limitation, the step of embossing is carried out separately from and subsequently to wrapping the pipe with the thermally insulated plastic wrap or coating the pipe with the thermally insulated coating.

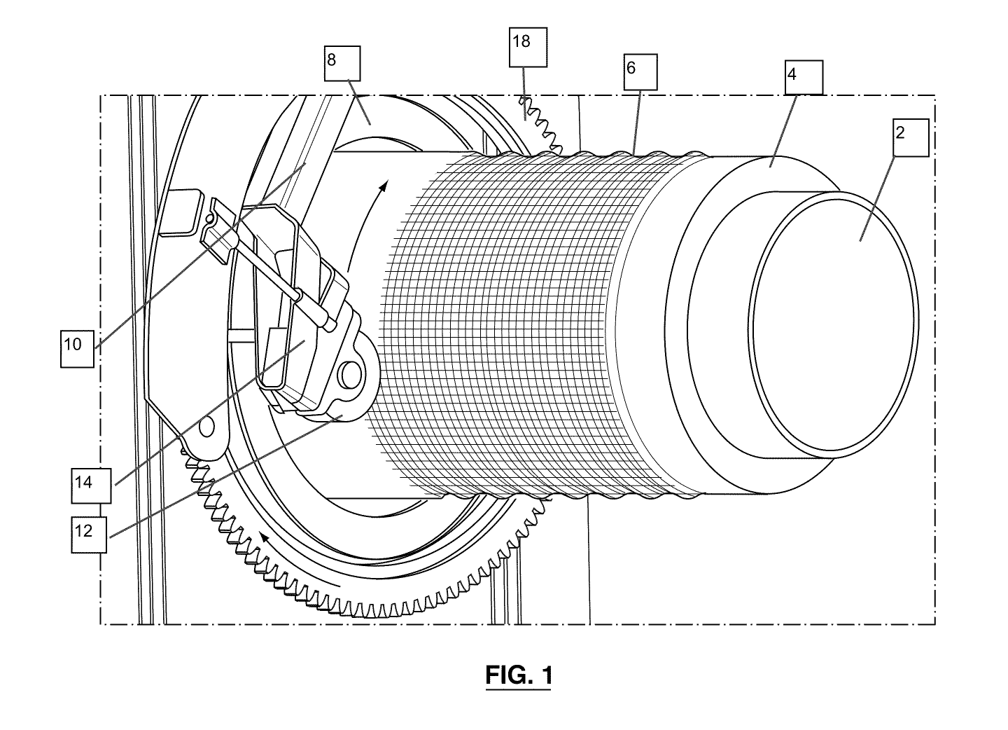

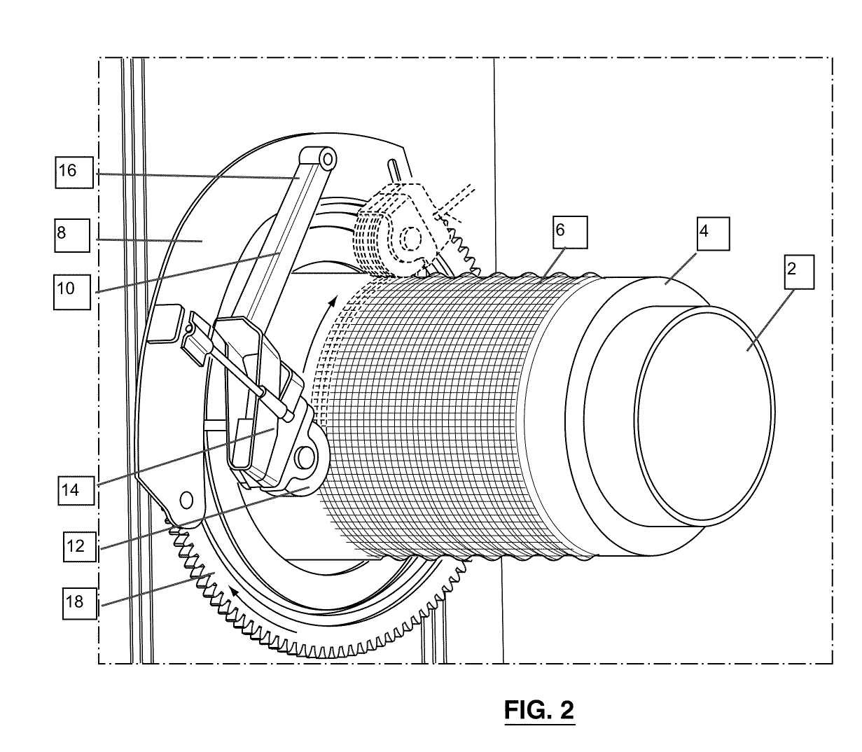

The step of embossing on the coating or the thermally insulated plastic wrap on a pipe is not particularly limited. In one embodiment, for example and without limitation, the step of embossing is performed using a similar device as shown in FIGS. 1 and 2. In such a device, the coated pipe or pipe (2) having the thermally insulating plastic wrap (4) is moved along the length of the pipe, while an impression (6) is formed using an embossing tool (8). Accordingly, means can be provided that can hold and/or move the pipe along the length of the pipe.

The size of the pipe having the coating or the thermally insulating plastic wrap is not particularly limiting and can depend upon the application requirements. In one embodiment, for example and without limitation, the pipe has a diameter ranging from 3 to 56 inches, and values in between.

As shown in FIGS. 1 and 2, the embossing tool (8) can revolve around the pipe. In one embodiment, for example and without limitation, the embossing tool revolves about the axis of the pipe. The embossing tool can have an arm (10) with an embossing wheel (12) attached to a first end (14) of the arm (10). While the other end (16) of the arm (10) is connected or coupled to some means (18) for moving the arm (10) about the axis of the pipe.

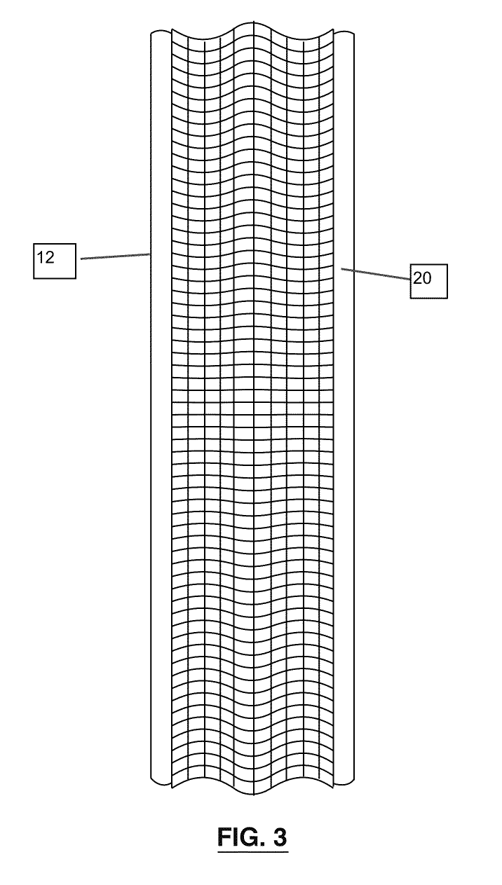

The embossing wheel (12) (FIG. 3) is typically coupled at its axis to the first end (14) of the arm (10), allowing the wheel (12) to rotate about its axis. The wheel (12) is also provided with a wheel face (20) that has a template formed thereon that can be used for embossing the impression on the coating or the thermally insulating plastic wrap (4) on the pipe (2). The embossing wheel face (20) has a width that can help determine the width of the embossed patter and the frequency. The width of the embossing wheel face (20) is not particularly limited and can depend upon the application requirements. In one embodiment, for example and without limitation, the embossing wheel face (20) has a width of from 10 to 300 mm, and values in between.

The amount of pressure applied using the embossing wheel (12) for the step of embossing can vary and can depend upon the particular application requirements. In addition, the material used for embossing is not particularly limited. In one embodiment, the embossing wheel is made of stainless steel.

The coating on the pipe (2) that undergoes the embossing is not particularly limited and can depend upon the application requirements. Similarly, the thermally insulating plastic wrap (4) on the pipe (2) is also not particularly limited and can depend upon the application requirements. In one embodiment, for example and without limitation, the thermally insulating plastic wrap (4) contains polyethylene, polypropylene, polystyrene, polyester, fluoropolymers, such as polyvinylidene fluoride (PVDF), polyvinyl fluoride (PVF), polyketone, polylsulfone, polyamide or mixtures thereof.

In addition to the above, the thermally insulating plastic wrap (4) can additionally contain rubbers and modifiers, which should be known to a skilled worker. The method and manner of applying the thermally insulating plastic wrap (4) on the pipe (2) is not particularly limited, and should also be known to a skilled worker.

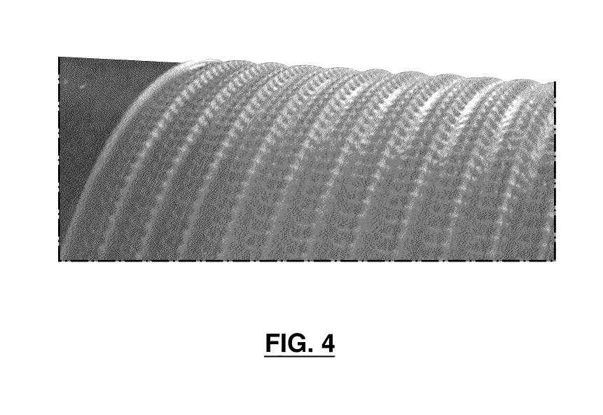

The process as disclosed herein can be used to make coated pipes or thermally insulated plastic wrapped pipes (2) that have surface features (FIG. 4) that can provide benefits, as should be recognized by those skilled in the art. In one embodiment, the controlled embossed surface can provide a surface for affixing concrete on the coated or thermally insulated plastic wrapped pipe having the embossed surface. Due to the controlled amplitude and/or frequency of the impressions, it can help to insure that the concrete adheres to the embossed surface.

Certain adaptations and modifications of the described embodiments can be made. Therefore, the above discussed embodiments are considered to be illustrative and not restrictive.

Parts list

| | |
|---|---|
| 2 | Pipe |
| 4 | plastic wrap |
| 6 | impression |
| 8 | embossing tool |
| 10 | arm |
| 12 | embossing wheel |
| 14 | first end of arm |
| 16 | other end of arm |
| 18 | means for moving arm |
| 20 | wheel face |

What is claimed is:

1. A process comprising embossing a surface of a thermally insulated plastic wrap or coating on a pipe, wherein the thermally insulated plastic wrap is wrapped on an outer surface of the pipe.

2. The process according to claim 1, further comprising irradiating the thermally insulated plastic wrap or coating prior to the step of embossing the thermally insulated plastic wrap.

3. The process according to claim 1, further comprising affixing concrete to the surface of the embossed pipe.

4. The process according to claim 1, wherein the step of embossing is performed concurrently and subsequently to wrapping or coating the pipe with the thermally insulated plastic wrap or coating.

5. The process according to claim 1, wherein the step of embossing is performed separately from and subsequently to wrapping or coating the pipe with the thermally insulated plastic wrap or coating.

6. The process according to claim 1, wherein the step of embossing is performed by moving the pipe along the length of the pipe; and forming an impression using an embossing tool.

7. The process according to claim 6, wherein the embossing tool revolves about the axis of the pipe.

8. The process according to claim 6, wherein the embossing tool comprises an arm having a first end coupled to a wheel, the wheel having a face about the circumference of the wheel, the face having a template for embossing; and a means for moving the arm about the axis of the pipe coupled to a second end of the pipe.

9. The process according to claim 8, wherein the face has width of from 10 to 300 mm.

10. The process according to claim 6, further comprising means for holding and moving the pipe along the length of the pipe.

11. The process according to claim 1, wherein the embossing forms an impression on the thermally insulated plastic wrap having a amplitude of from 1 to 10 mm.

12. The process according to claim 1, wherein the embossing forms an impression on the thermally insulated plastic wrap having a frequency of from 1 to 100 mm.

13. The process according to claim 1, wherein the pipe has a diameter of from 3 inches to 56 inches.

14. The process according to claim 1, wherein the thermally insulated plastic wrap comprises polyethylene, polypropylene, polystyrene, fluoropolymers, such as polyvinylidene fluoride (PVDF), polyvinyl fluoride (PVF), polyketone, polylsulfone, polyamide or mixtures thereof.

15. The process according to claim 14, further comprising rubbers and modifiers.

16. A product produced according to the process as defined in claim 1.

17. A concrete coated pipe comprising a pipe having an embossed thermally insulated plastic wrap layer; and a concrete layer affixed to the embossed thermally insulated plastic wrap layer.

18. The concrete coated pipe according to claim 17, wherein the embossed thermally insulated plastic wrap layer has an impression having amplitude of from 1 to 10 mm.

19. The concrete coated pipe according to claim 17, wherein the embossing forms an impression on the thermally insulated plastic wrap having a frequency of from 1 to 100 mm.

20. The concrete coated pipe according to claim 17, wherein the pipe has a diameter of from 3 inches to 56 inches.
